(19) United States
(12) Patent Application Publication
(10) Pub. No.: US 2006/0084458 A1
(43) Pub. Date: Apr. 20, 2006

(54) Adaptive power control mode apparatus and method for increased radio frequency link capacity

(75) Inventors: Gigy S. Mammarappallil, Arlington Heights, IL (US); Tyler A. Brown, Mundelein, IL (US); Alfredo R. Castillo, Palatine, IL (US)

Correspondence Address: MOTOROLA, INC., 1303 EAST ALGONQUIN ROAD, IL01/3RD, SCHAUMBURG, IL, 60196, US

(73) Assignee: Motorola, Inc.

(21) Appl. No.: 10/955,367

(22) Filed: Sep. 30, 2004

(51) Int. Cl. H04B 7/00

(52) U.S. Cl. 455/522; 455/69

(57) ABSTRACT

A method of adaptive power control in an electronic device comprising the steps of receiving a signal from a wireless radio access network indicating a method for setting a supplemental threshold; determining a value for the supplemental threshold utilizing the indicated method from the RAN; and setting the supplemental threshold. A method for calculating a supplemental threshold for an electronic device comprising utilizing a first variable and/or combinations of variables to determine an indication of a radio frequency environment and/or data burst activity levels of an electronic device; and sending a signal to the electronic device indicating a method for setting a supplemental threshold of the electronic device. Another embodiment includes an electronic device autonomously selecting a method to set supplemental threshold at the beginning of a data burst.

### FIELD OF THE INVENTION

The present invention relates generally to communication systems. More specifically, the present invention relates to increasing data capacity in communication systems.

### BACKGROUND

Wireless communication systems are widely used for many different purposes. More and more people every day purchase cellular telephones or other wireless communication devices, including but not limited to pagers, computers, and Personal Digital Assistants (PDA's). These electronic devices and others are capable of receiving and transmitting information using a communication system such as a cellular network.

One place people use their wireless communication device is when traveling (for example, when driving in a car, riding a bus, or riding in a taxi). Other places include their home, office or in an airport. The wide spread use of wireless communication devices (i.e., electronic devices) has become a part of everyday life for many people. Additionally, electronic devices are used more and more frequently in cellular systems for not only telephone calls (i.e., voice communications), but also for data transfer.

Third generation (3G) cellular systems, such as, CDMA2000 and WCDMA, are designed for both voice calls and high speed data transmission. The high speed data transmission capabilities are used for, amongst other things, downloading web-pages (e.g. Short Message Service (SMS) type downloads), downloading files (e.g. File Transfer Protocol (FTP) downloads), sending and receiving pictures, wireless multi-media or interactive video games, or any other type of data transmission. 3G cellular systems have dedicated data transmission channels (e.g., a supplemental channel) that are used for high speed data transmissions. Unfortunately the effective data transmission rate on such a supplemental channel can be slowed down for many different reasons, e.g., having a higher than desired frame error rate (FER) thereby causing increased re-transmission of data.

### BRIEF DESCRIPTION OF THE DRAWINGS

The features and advantages of the present invention will be apparent from the following description, presented in conjunction with the following drawings wherein:

FIG. 1 is a diagram illustrating the reception and transmission of signals between a RAN (Radio Access Network) and an electronic device in accordance with one embodiment;

FIG. 2 is a graph illustrating a fundamental channel threshold and a supplemental channel threshold for an electronic device, such as in FIG. 1, in a changing radio frequency (RF) environment in accordance with one embodiment;

FIG. 3 is a graph illustrating a fundamental channel threshold and a supplemental channel threshold for an electronic device, such as in FIG. 1, in stable RF environment in accordance with another embodiment;

FIG. 4 is a diagram illustrating different variables that can be utilized to determine a method for setting a supplemental channel threshold during data transfer transitions from dormant mode to active mode in accordance with one embodiment of the system shown in FIG. 1;

FIG. 5 is a diagram illustrating the reception of signals from multiple base stations in a RAN (Radio Access Network) at an electronic device in accordance with an alternative embodiment;

FIG. 6 is a diagram illustrating the reception of a multi-path signal from a base station at an electronic device in accordance with yet another embodiment;

FIG. 7 is a flow diagram illustrating a method of setting a supplemental threshold in an electronic device in accordance with one embodiment;

FIG. 8 is a flow diagram illustrating a method of sending a signal to an electronic device in order to set a supplemental channel threshold of the electronic device in accordance with one embodiment; and

FIG. 9 is a flow diagram illustrating a method of setting a supplemental threshold in an electronic device in accordance with another embodiment.

Corresponding reference characters indicate corresponding components throughout the several views of the drawings. Skilled artisans will appreciate that elements in the figures are illustrated for simplicity and clarity and have not necessarily been drawn to scale. For example, the dimensions, sizing, and/or relative placement of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will also be understood that the terms and expressions used herein have the ordinary meaning as is usually accorded to such terms and expressions by those skilled in the corresponding respective areas of inquiry and study except where other specific meanings have otherwise been set forth herein.

### DETAILED DESCRIPTION

The following description is not to be taken in a limiting sense, but is made merely for the purpose of describing the general principles of the invention. The scope of the invention should be determined with reference to the claims. The present embodiments address the problems described in the background while also addressing other additional problems as will be seen from the following detailed description.

One embodiment can be characterized as a method of adaptive power control in an electronic device comprising the steps of receiving a signal from a RAN (radio access network) indicating a method for setting a supplemental threshold; determining a value for the supplemental threshold utilizing the indicated method from the RAN (radio access network); and setting the supplemental threshold.

Another embodiment provides a method for calculating a supplemental threshold for an electronic device comprising utilizing a first variable to determine an indication of a radio frequency environment of an electronic device; and sending a signal to the electronic device indicating a method for setting a supplemental threshold of the electronic device.

Yet another embodiment includes an electronic device having an adaptive power control mode comprising means for receiving a signal from a Radio Access Network (RAN), the signal selecting a method for setting a supplemental threshold; means for determining a value for the supplemental channel threshold utilizing the indicated method from the RAN; and means for setting the supplemental threshold.

An alternative embodiment includes a system for calculating a supplemental threshold for an electronic device comprising means for utilizing a first variable to determine an indication of a radio frequency environment of an electronic device when it begins to transmit data either during a continuous data transfer session or when coming back into active mode from dormant mode; and means for sending a signal to the electronic device indicating a method for setting a supplemental threshold of the electronic device.

These various embodiments tend to allow for an increased data transmission rate as compared to prior systems. The various embodiments can be implemented on, for example, a third generation (3G) cellular system, such as, CDMA2000 and WCDMA, however other systems can also be utilized in accordance with the present embodiments.

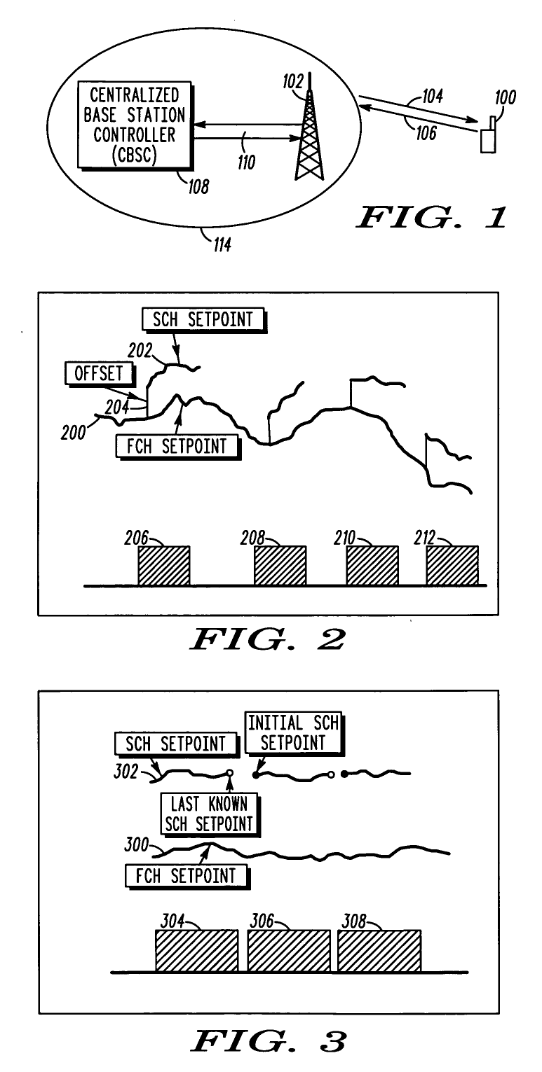

Referring to FIG. 1 a diagram is shown illustrating the reception and transmission of signals between a base station and an electronic device in accordance with one embodiment. Shown is an electronic device 100, a base station 102, a forward link signal 104, a reverse link signal 106, a centralized base station controller 108, communication lines 110, and a radio access network 114 (also referred to as the RAN 114).

The RAN 114 includes the centralized base station controller 108, the communication lines 110 and the base station 102. Such a configuration is utilized, for example, in third generation cellular systems.

The electronic device 100 is any device capable of communicating with the RAN 114 through the base station 102, such as is known in the art. In one embodiment, the electronic device 100 is a cellular telephone, a computer, a notebook, a PDA, a pager, or a two-way pager.

Generally, in operation, the electronic device 100 will request data to be transferred from the RAN 114. The request is sent over the reverse link signal 106 and the data is transferred back to the electronic device 100 from the RAN 114 over the forward link signal 104. The data is transferred over the forward link signal 106 in a burst. In CDMA2000 systems a burst consists of a certain number of frames (e.g. 16 or 32 frames of data over 320 or 640 milliseconds). While the following description will describe communications utilizing bursts in a CDMA2000 system, the present embodiments are not limited to these particular bursts. The present embodiments can be utilized in any system for which data is transmitted in segments over a communication network.

In CDMA2000 systems, data is transferred over a supplemental channel, while signaling, data, and voice are transferred over a fundamental channel. In operation, the fundamental channel will be continuously being used for the transfer of data, voice or signaling from the base station to the electronic device. The electronic device 100 has an internal fundamental channel set-point (also referred to herein as a fundamental threshold or fundamental channel threshold) that is updated every frame (e.g. 20 milliseconds). The fundamental channel set-point is a reference that is used by the electronic device 100. The electronic device 100 compares the received power on the fundamental channel of the forward link signal 104 to the fundamental channel set-point. Based upon this comparison, the electronic device can send up or down power requests back to the base station. Additionally, at the end of every frame, the fundamental channel set-point is adjusted either up or down depending upon whether the frame is correctly read by the electronic device 100 or if the frame is received in error. In general, this will keep the frame error rate (FER) on the fundamental channel at target frame error rate (e.g. 1%) without much deviation because it is continuously being updated.

The supplemental channel is utilized for data transmission only. The electronic device 100 has an internal supplement channel set-point (also referred to herein as a supplemental threshold or supplemental channel threshold) that is updated every frame (e.g. 20 milliseconds) during a burst. As described, data is transferred to the electronic device 100 during the burst. During the burst, the supplemental threshold is adjusted similarly to the fundamental threshold. That is, at the end of every frame within the burst the supplemental threshold is adjusted either up or down depending upon whether the frame is correctly read by the electronic device 100 or if the frame is received in error.

A problem arises however at the beginning of a second burst of data. This is because there is a time period between bursts for which no data is transmitted on the supplemental channel. If the supplemental threshold is set at the beginning of each burst by adding an offset value to the fundamental threshold under steady RF conditions or when coming back into active mode from dormant mode or when the delay between data bursts is short, this can cause the frames at the beginning of a burst to be received in error by the electronic device 100 and/or result in wasted RF capacity by the RAN 114. This is due to the supplemental threshold being set too low or too high. Conversely, if the supplemental channel threshold is set at the beginning of every data burst by re-using the threshold from previous data burst under varying RF conditions or when coming back into active mode from dormant mode or when the delay between data bursts is long, again, this can cause the frames at the beginning of a burst to be received in error by the electronic device 100 or waste RF capacity. For example, the first five frames can be received in error before the supplemental threshold is set to the correct value. As another example, on average, between the first three to five frames of a burst can be received in error. Each time a frame is received in error, the frame will need to be resent to the electronic device 100. Therefore, having a high FER contributes to a low effective data transmission rate.

Therefore, in accordance with the present embodiments it is advantageous to have a system, apparatus and method for setting the supplemental threshold value at the beginning of a burst such that the number of frames at the beginning of a burst that are received in error is kept within an acceptable range and wasted RF capacity is kept to a minimum. In one embodiment of the present invention, the base station 102 will send a signal to the electronic device 100 at the beginning of a burst or just before a burst. The electronic device 100 will set the supplemental threshold using one of two or more methods based upon receipt of the signal. The electronic device 100 will set a supplemental threshold that is likely to result in an acceptable number of errors at the beginning of a burst and a minimum of waste in RF capacity.

In present systems, the supplemental threshold is always reset at the beginning of a burst to the fundamental threshold value plus an offset value or supplemental channel threshold initialized to the last known supplemental channel threshold at the electronic device 100 without considering whether the radio frequency (RF) environment for the electronic device has changed or has remained steady without considering the delay between data bursts, and without considering the mobility and static characteristics of electronic device 100. Therefore, a system in accordance with the present embodiments that takes into consideration changes in the RF environment and delay between data transfer bursts of the electronic device 100 improves data transmission rates on the supplemental channel.

Referring to FIG. 2 a graph is shown illustrating a fundamental threshold and a supplemental threshold for an electronic device, such as in FIG. 1, in a changing RF environment in accordance with one embodiment. Shown is a fundamental channel set-point 200 (also referred to as the fundamental threshold), a supplemental channel set-point 202 (also referred to as the supplemental threshold), an offset value 204, a first burst 206, a second burst 208, a third burst 210, and a fourth burst 212.

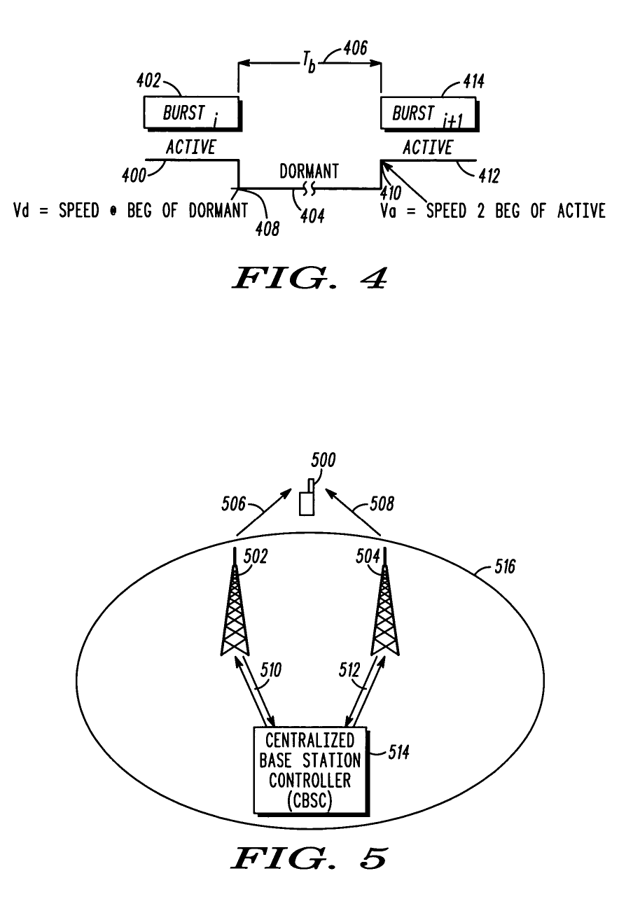

As shown, the fundamental threshold 200 is fluctuating up and down. The fluctuation of the fundamental threshold 200 is indicative of a changing RF environment. For example, a mobile user currently driving within an urban environment can experience such a fundamental threshold 200 profile. The base station 102, the RAN 114 and the electronic device 100 can use a number of different methods or variables (described herein in greater detail with reference to FIGS. 4-6) to determine or indicate that a change in, e.g., the RF environment, speed, number of forward links in active set, energy and number of rays detected by rake fingers, and/or delay between data bursts including transitions from dormant to active session of the electronic device 100 has occurred or most likely has occurred. In one embodiment, when such a change or changes are detected by the electronic device 100 or the RAN 114 before the start of a data burst, the RAN 114 sends a signal to the electronic device 100. The signal indicates to the electronic device 100 that the supplemental threshold 202 should be set as the value of the fundamental threshold 200 plus the offset value 204. As is shown, the supplemental threshold 202 for each of the first burst 206, the second burst 208, the third burst 210, and the fourth burst 212 is set at the value of the fundamental threshold 200 plus the offset value 204.

FIG. 2 illustrates one method of setting the supplemental threshold 202 of an electronic device 100. The electronic device 100 sets the supplemental threshold 202 in this manner upon receipt of a signal from the base station 102 through the RAN 114. For example, the RAN 114 can populate the initial supplemental channel set-point field (or supplemental threshold field) in the Extended Supplemental Channel Allocation Message. In one embodiment, populating the initial supplemental channel set-point field will indicate to the electronic device 100 that the supplemental threshold 202 for the beginning of a burst (e.g., the first burst 206) should be derived from the current fundamental channel set-point 200 plus the offset value 204.

In one embodiment, FIG. 2 illustrates a fundamental channel threshold profile for a mobile user in a varying RF environment or a user with a short message service (SMS) call profile or a user that has a changed RF environment when transitioned from dormant to active data transfer session.

Referring to FIG. 3 a graph is shown illustrating a fundamental threshold and a supplemental threshold for an electronic device, such as in FIG. 1, in stable environment in accordance with another embodiment. Shown is a fundamental channel set-point 300, a supplemental channel set-point 302, a first burst 304, a second burst 306, and a third burst 308.

In contrast to FIG. 2, the fundamental channel set-point 300 (also referred to as the fundamental threshold) is relatively constant and has only minor fluctuations. This fundamental threshold 300 profile is indicative of an RF environment that doesn't change between data bursts. In one embodiment, the fundamental channel profile shown illustrates a stationary user or a user with short delay between supplemental channel data bursts or a user with an FTP call profile. For example, a user sitting at a table or sitting at a desk at work may have a fundamental threshold 300 profile such as is shown in FIG. 3. Similarly to FIG. 2, the RAN 114 can use a number of different methods or variables (described herein in greater detail with reference to FIGS. 4-6) to determine or indicate that a steady RF environment of the electronic device 100 has occurred or most likely has occurred or that the delay between supplemental channel data bursts is short. When such an RF environment in detected or indicated, the base station 102 will send a signal to the electronic device 100. The signal indicates to the electronic device 100 that the supplemental threshold 302 should be set as the value of the supplemental threshold at the end of the previous burst (i.e., re-use the last known supplemental threshold to initialize current data burst). For example, the initial supplemental threshold 302 at the beginning of the second burst 306 is set to the same value as the supplemental threshold 302 at the end of the first burst 304. Similarly, the initial supplemental threshold 302 at the beginning of the third burst 308 is set to the same value as the supplemental threshold 302 at the end of the second burst 306.

FIG. 3 illustrates a second method of setting the supplemental threshold 302 of an electronic device 100. The electronic device 100 sets the supplemental threshold 302 in this manner upon receipt of a signal from the base station 102. For example, the base station can set the initial supplemental channel set-point field (or supplemental threshold field) in the Extended Supplemental Channel Allocation Message to nil. In one embodiment, setting the initial supplemental channel set-point field to nil will indicate to the electronic device 100 that the supplemental threshold 302 for the beginning of a burst (e.g., the second burst 208) should be derived from the supplemental channel set-point 200 at the end of the previous burst.

Referring to FIG. 4 a diagram is shown illustrating different variables that can be utilized to determine a method for setting a supplemental channel threshold during data transfer transitions from dormant mode (i.e., no data transfer) to active mode (i.e., data transfer is enabled) in accordance with one embodiment of the system shown in FIG. 1. Shown is a first active mode 400, a first burst 402, a dormant mode 404, a delay between bursts 406, a first velocity 408, a second velocity 410, a second active mode 412, and a second burst 414.

During the first active mode 400 and the second active mode 412 the first burst 402 and the second burst 414 are respectively transmitted from the base station 102 to the electronic device 100 (shown in FIG. 1). During the dormant period, there is no data (i.e., no frames or bursts) transmitted over the supplemental channel. The delay between bursts 406 is equal to the delay between burst measured by RAN or electronic device 100. The delay between bursts 406 (also referred to as a data burst activity timer) is also a measure of data burst activity on forward link. The RAN 114 and electronic device 100 know or can measure or estimate time between bursts 406 and the RAN 114 can utilize this variable in order to determine a signal to send to the electronic device 100 (e.g., setting the initial supplemental channel set-point field in the Extended Supplemental Channel Allocation Message or setting to NIL.). Based upon the value of the received signal or the delay threshold between bursts (data burst activity threshold/timer) set internally at the electronic device 100 determines a method of calculating the supplemental threshold value for the beginning of the second burst 414. For example, the received signal will indicate to the electronic device 100 whether to set the supplemental threshold value based upon the fundamental threshold or based upon the supplemental threshold value at the end of the first burst 402.

The delay between bursts 406 (also referred to as a data burst activity timer or duration of inactivity timer) is utilized in one embodiment by the RAN 114 to determine a signal to send to the electronic device 100 for setting the supplemental threshold. The delay between bursts 406 is but one variable that can be utilized by the RAN 114 in order to determine the signal to send to the electronic device 100 and can be used by itself or in combination with other variables. Other variables that can be utilized will be described herein below. Additionally, described below is one method of utilizing variables in combination to determine the signal to send to the electronic device 100 for setting the initial supplemental threshold at the beginning of a burst. A long delay between consecutive bursts is indicative that the RF environment more than likely has changed since the transmission of the first burst 402. As stated above, if the RF environment has changed or more than likely has changed, the initial supplemental threshold for the beginning of the second burst 414 will be set as a function of the fundamental threshold plus an offset value. However, if the delay between bursts 406 is relatively short, there is less likely a change in the RF environment and the base station will send a signal to the electronic device 100 indicating that the initial supplemental threshold for the second burst 414 should be set utilizing the supplemental threshold value from the end of the first burst 402. Based on comparison to the delay between bursts 406 and activity or delay threshold set internally at the electronic device 100, the electronic device 100 can also independently select from one of the two methods mentioned above or other methods. This allows for the electronic device to select between one of the two methods independently from the RAN 114.

A second variable that can be utilized either by itself or in combination with other variables to determine the initial supplemental threshold at the beginning of a burst is the velocity or change in velocity of the electronic device 100. One method for determining the velocity of an electronic device 100 is described in U.S. Pat. No. 5,787,348, issued Jul. 28, 1998, entitled Method of measuring speed of a mobile unit and a receiver for use in a wireless communication system, to Willey et al., and assigned to Motorola, Inc.

The change in velocity is calculated by taking the absolute value of the first velocity 408 minus the second velocity 410 (i.e., |Va−Vd|). A large change in velocity tends to indicate a change in the RF environment, while a relatively small change in velocity indicates a stable RF environment. Thus, the change in velocity can be used to determine a signal to be sent to the electronic device 100 that is used to determine a method for setting the supplemental threshold at the beginning of the second burst 414.

Following is an example of utilizing more than one variable in order to determine a signal to be sent to the electronic device 100 that is used to determine a method for setting the supplemental threshold at the beginning of the second burst 414. Let Di(Va,Vd) be a function of the variables Va, Vd. If Th>dt and |Va−Vd|>Di(Va,Vd), when a user is transitioning from dormant to active (e.g. a mobile user), the RAN 114 will send a signal (e.g., by populating an Extended Supplemental Channel Message field) indicating to the electronic device 100 that the initial Supplemental Channel should be set to the current Fundamental Channel set-point plus an Initial Supplemental Channel Offset.

Where: Th is the time between the first burst and the second burst; dt is a predetermined length of time (e.g., 2 seconds); Va is the velocity of the electronic device 100 at the end of the first burst 402; Vd is the velocity of the electronic device 100 at the end of the dormant time 406; and Di is a predetermined change in velocity (e.g., Di(Va,Vd) can be:

$$Di ( Va , Vd ) = \{ \begin{matrix}10 , & Vi < 30 km \text{/} h or Vd < 30 km \text{/} h \\ 25 , & otherwise\end{matrix}$$

Alternatively, if Th<dt and |Va−Vd|<Di(Va,Vd), when a user is transitioning from dormant to active (e.g., a pedestrian/stationary user), the RAN will send a signal (e.g., without populating an Extended Supplemental Channel Message field) indicating to the electronic device 100 that the initial Supplemental Channel should be set to the value of the Supplemental Channel Offset of the final frame from previous the first burst 402 (i.e., the last known SCH set point).

Referring to FIG. 5 a diagram is shown illustrating the reception of signals from multiple base stations at an electronic device in accordance with one embodiment. Shown is an electronic device 500, a first base station 502, a second base station 504, a first forward link signal 506, a second forward link signal 508, a first set of communication lines 510, a second set of communication lines 512 a centralized base station controller 514 and a RAN 516.

Two base stations are shown in FIG. 5 in an exemplary manner, however, the electronic device 500 receives signals from more than two base stations in other embodiments.

As is shown, the electronic device 500 receives the first forward link signal 506 from the first base station 502. The electronic device 500 receives the second forward link signal 508 from the second base station 504. The RAN 516, via the first base station 502 and the second base station 504, is aware of how many signals the electronic device 500 is receiving. This is described in greater detail in A. J. Viterbi, CDMA: Principles of Spread Spectrum Communication, Reading, Mass. Addison Wesley, 1995. Additionally, the RAN 516 via the first base station 502 and the second base station 504 is aware of a change in the number of forward link signals the electronic device 500 is receiving. The number of forward link signals, e.g., two in the present example, or a change in the number of forward link signals is another variable that is utilized in alternative embodiments by a base station to determine a signal to be sent to the electronic device 500 that indicates the method of setting the supplemental threshold at the beginning of a burst.

For example, a change in the number of forward link signals received by the electronic device 500 (e.g., from two signals to one signal) indicates a change in the RF environment. Thus, the RAN 516 will send a signal to the electronic device 500 that indicates to the electronic device 500 that the supplemental threshold for the beginning of the next burst should be set as the value of the fundamental threshold plus the offset value. Alternatively, electronic device 500 can independently choose to set supplemental threshold for the beginning of the next burst should be set as the value of the fundamental threshold plus the offset value based on a change in the number of forward link signals received by the electronic device 500.

Alternatively, no change in the number of forward link signals received by the electronic device 500 indicates a steady RF environment. Thus, the RAN will send a signal to the electronic device 500 that indicates to the electronic device 500 that the supplemental threshold for the beginning of the next burst should be set to the value of the supplement threshold at the end of the previous burst. Additionally, electronic device 500 can independently choose to set supplemental threshold for the beginning of the next burst should be set as the value of the fundamental threshold plus the offset value based on a change in the number of forward link signals received by the electronic device 500.

In addition to the change in the number of forward link signals received from different base stations, the number of forward link signals received by the electronic device 500 from different antenna at the same base station are utilized in one embodiment as a variable to determine a signal that is sent to the electronic device 500 indicating a method for setting the supplemental threshold at the beginning of a burst. In another embodiment, a change in the number of forward link signals received by the electronic device 500 from different antenna at the same base station is utilized as a variable to determine the signal that is sent to the electronic device 500.

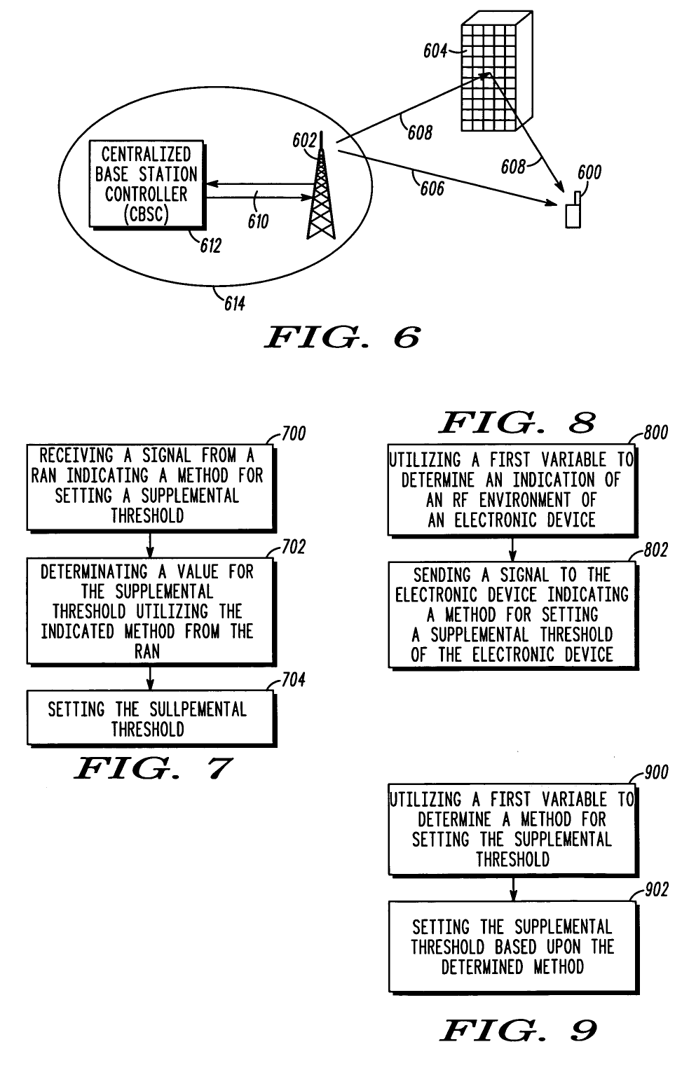

Referring to FIG. 6 a diagram is shown illustrating the reception of a multi-path signal from a base station at an electronic device in accordance with yet another embodiment. Shown is an electronic device 600, a base station 602, a building 604, a first direct signal path 606, a second reflected signal path 608, communication lines 610, a centralized base station controller 612 and a RAN 614.

As is shown, the electronic device 600 receives a forward link signal from the base station 602 over both the first direct signal path 606 and the second reflected signal path 608. The first direct signal path 606 indicates a signal with strong energy to noise ratio directly from the base station 602 to the electronic device. The second signal path 608 indicates a signal with less strong energy to noise ratio from the base station 602, reflected off of the building 604 and then to the electronic device 600. Each of the signals received over the separate paths are known as a ray. In CDMA2000 systems a rake finger is assigned to each ray. The RAN 614, via the base station 602, and electronic device 600 can identify the number and energy to noise ratio of rays and can also identify a change in the number of rays and a change in the energy to noise ratio of rays received at the electronic device 600. This is described in greater detail in R, C. Dixon, Spread Spectrum Systems with Commercial Applications, New York, Wiley, 1994. Again, the information can be utilized by the RAN as a variable (by itself or in combination with other variables) to send a signal to the electronic device 600 that is indicative of how the electronic device 600 will set the supplement threshold at the beginning of the next received burst. A change in the number of rays and change in energy to noise ratio of rays are indicative of a change in the RF environment for the electronic device 600. Also, based on the knowledge of change in the number of rays and change in energy to noise ratio of rays, the electronic device 600 can independently (e.g., without signaling from the RAN) choose to set supplemental threshold for the beginning of the next burst from the two methods.

While five different variables have been described herein for use in determining either a change in the RF environment, a steady RF environment or the data burst activity factor (a delay between bursts) on forward channels, other variables can be utilized in alternative embodiments. All of the variables give an indication of the RF environment of the electronic device.

Referring to FIG. 7 a flow diagram is shown illustrating a method of setting a supplemental threshold in an electronic device in accordance with one embodiment.

In step 700, a signal is received from a RAN via a base station indicating a method for setting a supplemental threshold. In one exemplary embodiment, the signal is part of an extended supplemental channel message.

In step 702, a value is determined for the supplemental threshold utilizing the indicated method from the RAN. In one embodiment, the signal from the RAN indicates whether the value is determined for the supplemental threshold by adding an offset to a fundamental threshold or whether the value is determined by using the value of a supplemental threshold from a previous burst.

Next, in step 704, the electronic device sets the supplemental threshold. For example, the supplemental threshold is set to the determined value of step 702.

Referring to FIG. 8 a flow diagram is shown illustrating a method of sending a signal to an electronic device in order to set a supplemental threshold of the electronic device in accordance with one embodiment.

In step 800, a first variable is utilized to determine indication of an RF environment of an electronic device. For example, a RAN will utilize one or more of the variables described with reference to FIGS. 4-6 to determine an indication of the RF environment of the electronic device or the data burst activity on forward channels.

In step 802, a signal is sent to the electronic device indicating a method for setting a supplemental threshold of the electronic device. In one embodiment, the signal from the RAN indicates whether the value is determined for the supplemental threshold by adding an offset to a fundamental threshold or whether the value is determined by using the value of a supplemental threshold from a previous burst. Alternatively, the electronic device independently sets the supplemental threshold for the beginning of the next data burst by selecting between the two methods.

Referring to FIG. 9 a flow diagram is shown illustrating a method of setting a supplemental threshold in an electronic device in accordance with another embodiment.

In step 900, a first variable is utilized by the electronic device to determine a method for setting the supplemental threshold. Next in step 902, the supplemental threshold is set by the electronic device based upon the determined method. In this embodiment, the electronic device is able to utilize one or more variables that are indicative of a radio frequency environment in order to determine a method for setting the supplemental threshold. Preferably, the electronic device autonomously (i.e., without receiving a signal from the RAN indicating a method of setting the supplemental threshold) selects one of two methods of setting the supplemental threshold.

While the invention herein disclosed has been described by means of specific embodiments and applications thereof, other modifications, variations, and arrangements of the present invention may be made in accordance with the above teachings other than as specifically described to practice the invention within the spirit and scope defined by the following claims.

We claim:

1. A method of adaptive power control comprising the steps of:
receiving a signal from a radio access network indicating a method for setting a supplemental threshold, wherein the method for setting the supplemental threshold is determined utilizing a first variable, the first variable indicative of a radio frequency environment;
determining a value for the supplemental threshold utilizing the indicated method from the radio access network; and
setting the supplemental threshold.

2. The method of claim 1 wherein the step of determining a value for the supplemental threshold comprises determining the supplemental threshold from a fundamental threshold.

3. The method of claim 1 wherein the step of determining a value for the supplemental threshold comprises determining the supplemental threshold from a value of the supplemental threshold at an end of a previous data burst.

4. The method of claim 1 wherein the step of receiving a signal from the Radio Access Network comprises receiving an extended supplemental channel message using an initial supplemental channel offset parameter.

5. A method of adaptive power control in an electronic device comprising:
utilizing a first variable to determine a method for setting a supplemental threshold; and
setting the supplemental threshold based upon the determined method.

6. The method of claim 5 wherein a value of the first variable is indicative of a radio frequency environment.

7. The method of claim 5 wherein a value of the first variable is indicative of a data burst activity level.

8. An electronic device having an adaptive power control mode comprising:
means for receiving a signal from a Radio Access Network indicating a method for setting a supplemental threshold, wherein the method for setting the supplemental threshold is determined utilizing a first variable, the first variable indicative of a radio frequency environment;
means for determining a value for the supplemental threshold utilizing the indicated method from the Radio Access Network; and
means for setting the supplemental threshold.

9. The electronic device of claim 8 wherein the means for determining a value for the supplemental threshold comprises means for determining the supplemental threshold from a fundamental threshold.

10. The electronic device of claim 8 wherein the means for determining a value for the supplemental threshold comprises means for determining the supplemental threshold from a value of the supplemental threshold at an end of a previous data burst.

11. The electronic device of claim 8 wherein the means for receiving a signal from the Radio Access Network comprises means for receiving an extended supplemental channel message using an initial supplemental channel offset parameter.

12. A method for calculating a supplemental threshold for an electronic device comprising:
utilizing a first variable to determine an indication of a radio frequency environment of an electronic device; and
sending a signal to the electronic device indicating a method for setting a supplemental threshold of the electronic device.

13. The method of claim 12 wherein the first variable is selected from a group of variables comprising a delay between data bursts, a change in velocity of an electronic device, a change in a number of signals the electronic device receives, a change in a number of rays the electronic device receives, and an energy to noise ratio of rays the electronic device receives.

14. The method of claim 12 further comprising utilizing a second variable along with the first variable to determine an indication of a radio frequency environment of the electronic device.

15. The method of claim 12 and further comprising determining a value for the supplemental threshold by determining the supplemental threshold from a fundamental threshold.

16. The method of claim 12 and further comprising determining a value for the supplemental threshold by determining the supplemental threshold from a value of the supplemental threshold at an end of a previous data burst.

17. The method of claim 12 wherein the step of sending a signal to the electronic device comprises sending an extended supplemental channel message using an initial supplemental channel offset parameter.

18. A system for calculating a supplemental threshold for an electronic device comprising:
means for utilizing a first variable to determine an indication of a data burst activity level of an electronic device; and
means for sending a signal to the electronic device indicating a method for setting a supplemental threshold of the electronic device.

19. The system of claim 18 wherein the first variable is selected from a group of variables comprising a delay between data bursts, a change in velocity of an electronic device, a change in the number of signals an electronic device receives, a change in the number of rays an electronic device receives, and an energy to noise ratio of rays an electronic device receives.

20. The system of claim 18 further comprising means for utilizing a second variable along with the first variable to determine an indication of a radio frequency environment of an electronic device.

21. The system of claim 18 wherein the means for sending a signal to the electronic device comprises means for sending an extended supplemental channel message using an initial supplemental channel offset parameter.

22. The system of claim 21 wherein the means for sending an extended supplemental channel message using an initial supplemental channel offset parameter includes populating the initial supplemental channel offset parameter to comprise a positive value.

23. The system of claim 21 wherein the means for sending an extended supplemental channel message using an initial supplemental channel offset parameter comprises setting the initial supplemental channel offset parameter to nil.
